(19) United States
(12) Patent Application Publication
(10) Pub. No.: US 2004/0179149 A1
(43) Pub. Date: Sep. 16, 2004

(54) Protective mask with a liquid crystal display panel

(76) Inventor: Anothony Wang-Lee, Yung-Kang City (TW)

Correspondence Address: WEBB ZIESENHELM LOGSDON ORKIN & HANSON P.C., 700 Koppers Building, 436 Seventh Avenue, Pittsburgh, PA, 15219-1818, US

(21) Appl. No.: 10/385,316

(22) Filed: Mar. 10, 2003

(51) Int. Cl. G02F 1/1333

(52) U.S. Cl. 349/58

(57) ABSTRACT

A protective mask includes a mask body having a front part formed with a window frame that defines a window. A viewing member is mounted in the window frame to cover the window, and permits vision therethrough. A liquid crystal display unit is disposed frontwardly of the window frame, and has a liquid crystal display panel. The liquid crystal display unit is pivoted to the window frame through a pivot unit so as to be movable relative the window frame between open and closed positions.

### BACKGROUND OF THE INVENTION

1. Field of the Invention

The invention relates to a protective mask, more particularly to a protective mask including a mask body that defines a front window, and a liquid crystal display unit having a panel-mounting frame detachably pivoted to the mask body and a liquid crystal display panel mounted on the frame for covering the front window.

2. Description of the Related Art

Referring to FIG. 1, a conventional protective mask 1 is shown to include a mask body 11 having a front part 112 that defines a front window 113, a flat viewing member 12 mounted securely on the front part 112 so as to cover the front window 113 and so as to permit vision therethrough, and a liquid crystal display unit 13 including a panel-mounting frame 131 that is mounted on the mask body 11 and disposed frontwardly of the viewing member 12, a liquid crystal display panel 132 that is mounted on the panel-mounting frame 131 so as to attenuate light radiation passing therethrough, and a transparent protective plate 133 that is mounted on the panel-mounting frame 131 and that is disposed frontwardly of the liquid crystal display panel 132 for protecting the latter.

One disadvantage of the aforesaid conventional protective mask 1 resides in that the panel-mounting frame 131 cannot be moved away from the front part 112 so as to permit checking of the actual working site through the viewing member 12. In addition, the user cannot see through left and right parts of the mask body 11, thereby limiting the viewing range and inconveniencing the user.

### SUMMARY OF THE INVENTION

Therefore, the object of this invention is to provide a protective mask that can overcome the aforementioned disadvantages associated with the conventional protective mask.

Accordingly, a protective mask of the present invention includes: a mask body having a front part formed with a window frame that protrudes frontwardly therefrom, the window frame defining a front window; a viewing member mounted in the window frame so as to cover the front window and adapted to permit vision therethrough; a pivot unit; and a liquid crystal display unit disposed frontwardly of and adjacent to the window frame, and having a liquid crystal display panel, the liquid crystal display unit being pivoted to the window frame through the pivot unit in such a manner that the liquid crystal display unit is movable relative to the window frame between a closed position, in which the liquid crystal display panel confronts and covers the viewing member, and an open position, in which the liquid crystal display panel is moved away from the window frame to expose the viewing member.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a fragmentary sectional side view of a conventional protective mask;

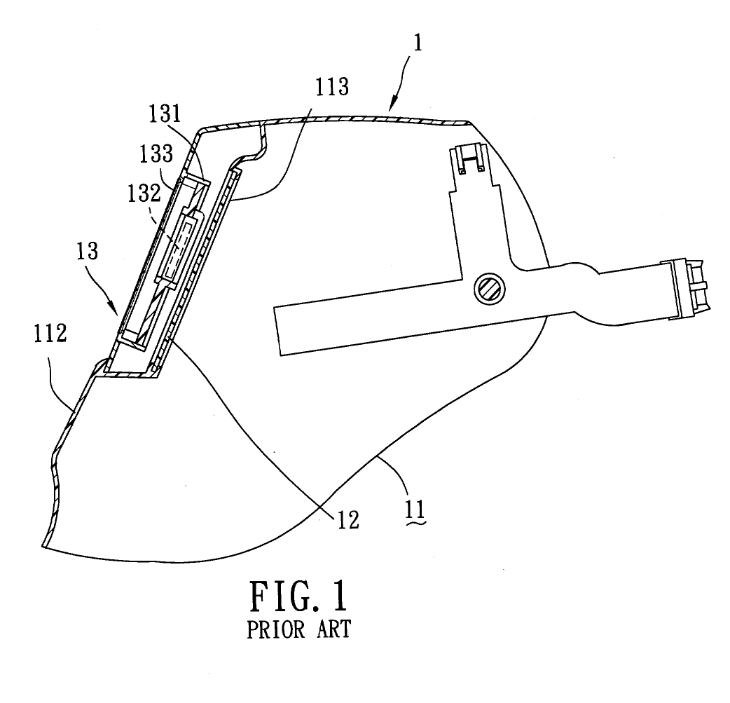

FIG. 2 is an exploded perspective view of the preferred embodiment of a protective mask according to the present invention;

FIG. 3 is an exploded fragmentary view of the preferred embodiment;

FIG. 4 is a perspective view of the preferred embodiment, illustrating how a panel-mounting frame is moved away from a mask body to an open position so as to expose a front viewing member;

FIG. 5 is a fragmentary sectional view of the preferred embodiment, illustrating the panel-mounting frame at a closed position to permit vision through the front viewing member and a liquid crystal display panel;

FIG. 6 is a fragmentary sectional view of the preferred embodiment, illustrating how the panel-mounting frame is retained at the open position to expose the front viewing member; and

FIG. 7 is a fragmentary sectional view of the preferred embodiment, illustrating how the panel-mounting frame is retained at a fully open position to expose the front viewing member.

### DETAILED DESCRIPTION OF THE PREFERRED EMBODIMENT

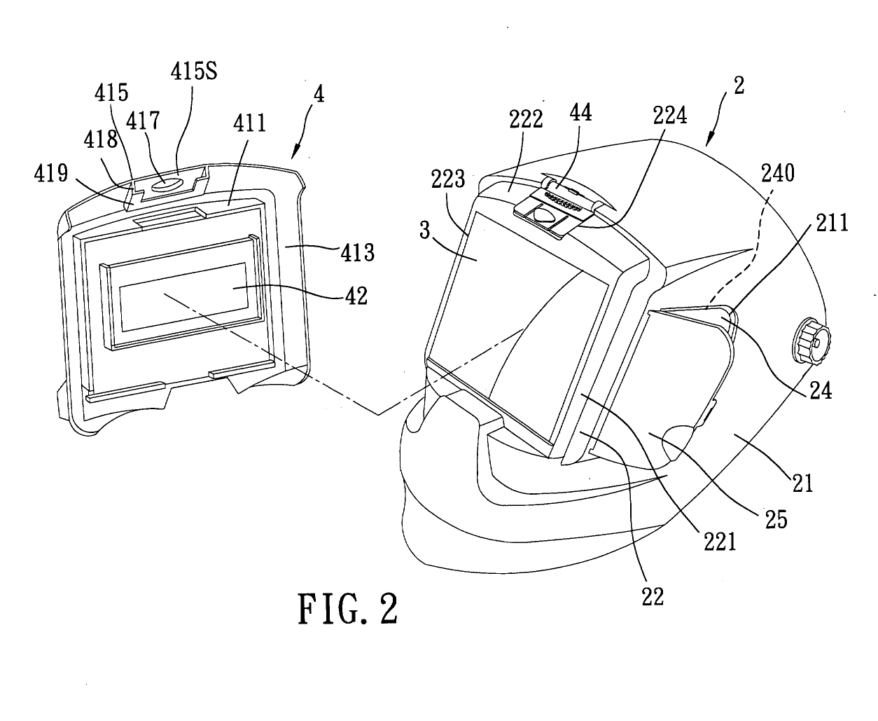

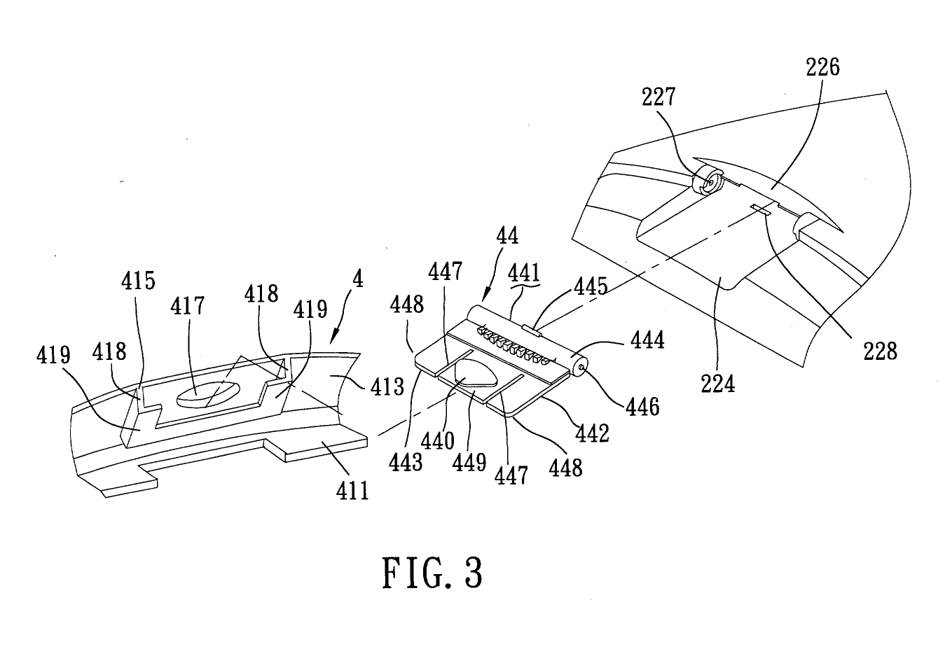

Referring to FIGS. 2, 3 and 4, the preferred embodiment of a protective mask according to the present invention is shown to include a mask body 2, a front viewing member 3, a pivot unit 44, a liquid crystal display unit 4, two side viewing members 24, and two side covers 25.

As illustrated, the mask body 2 has a front part 22 formed with a window frame 221 protruding frontwardly therefrom. The window frame 221 defines a front window 223.

The front viewing member 3 is mounted in the window frame 221 so as to cover the front window 223 and so as to permit vision therethrough.

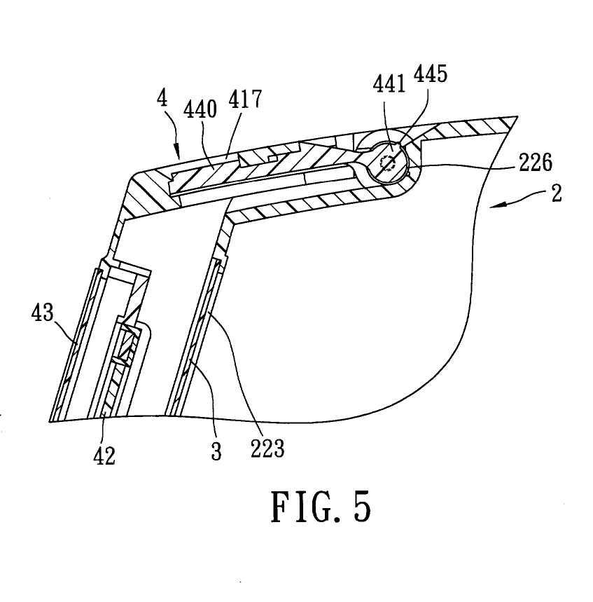

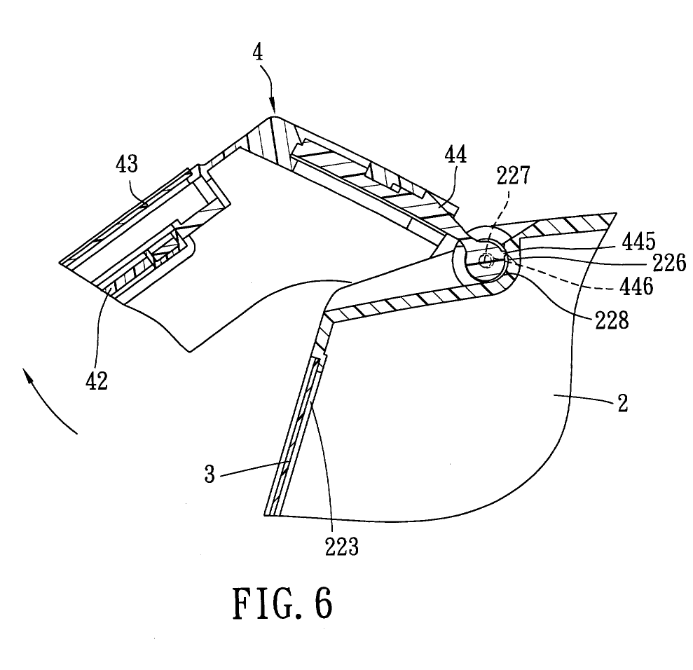

The liquid crystal display unit 4 is disposed frontwardly of and adjacent to the window frame 221, and has a liquid crystal display panel 42. The liquid crystal display unit 4 is pivoted to the window frame 221 through the pivot unit 44 in such a manner that the liquid crystal display unit 4 is movable relative to the window frame 221 between a closed position, in which the liquid crystal display panel 42 confronts and covers the front viewing member 3, as best shown in FIG. 5, and an open position, in which the liquid crystal display panel 42 is moved away from the window frame 221 to expose the front viewing member 3, as best shown in FIG. 6.

In this embodiment, the liquid crystal display unit 4 includes a panel-mounting frame 411 with a peripheral flange 413 projecting rearwardly from a periphery of the panel-mounting frame 411 toward the window frame 221. The peripheral flange 413 has a top portion 414 formed with a pocket 415 that defines a pocket space (415S) therein and that projects rearwardly from the top portion 414. The pocket 415 has left and right side plates 418 and a rear plate 419 interconnecting the side plates 418 and confronting the top portion 414 of the peripheral flange 413. The top portion 414 of the peripheral flange 413 is formed with a retaining opening 417 that confronts the rear plate 419 of the pocket 415.

The pivot unit 44 includes an engaging plate 442 having a pivot end 441 pivoted to the window frame 221 above the front viewing member 3, a free end 443 opposite to the pivot end 441, and two opposite sides 448 extending from the free end 443 to the pivot end 441. The engaging plate 442 is formed with two opposite slits 447 that extend from the free end 443 toward the pivot end 441 to define a latch 449 therebetween. The latch 449 is elastic and is formed with a protrusion 440. The engaging plate 442 is inserted into the pocket space (415S) in the pocket 415 in such a manner that the side plates 418 of the pocket 415 abut respectively against the opposite sides 448 of the engaging plate 442 and that the protrusion 440 projects into and engages the retaining opening 417 in the top portion 414 of the peripheral flange 413, thereby preventing untimely removal of the panel-mounting frame 411 from the window frame 221. When it is desired to remove the panel-mounting frame 411 from the window frame 221, the protrusion 440 can be pressed inwardly into the pocket space (415S), and the panel-mounting frame 411 is simultaneously pulled away from the window frame 221. Preferably, a transparent plate 43 is mounted on the panel-mounting frame 411, and is disposed frontwardly of the liquid crystal display panel 42 so as to protect the latter.

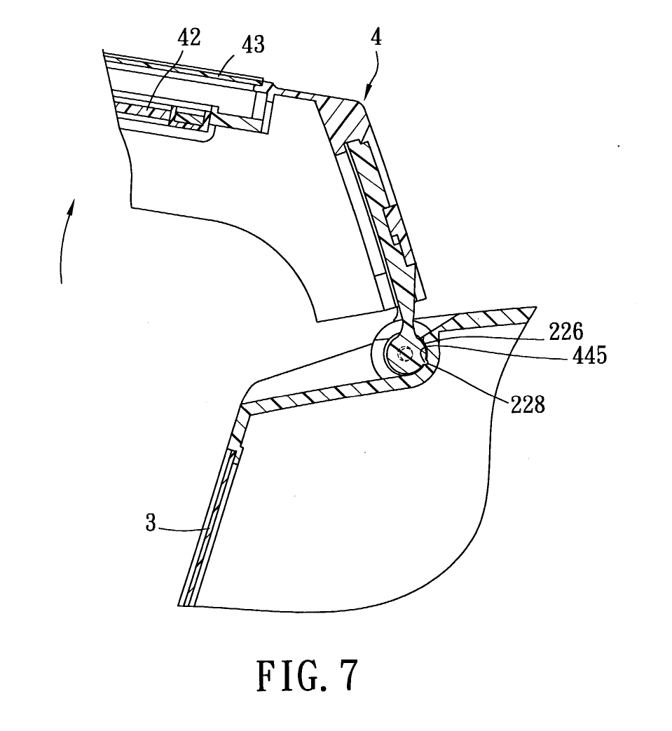

The pivot unit 44 further includes a shaft 444 connected to the pivot end 441 of the engaging plate 442. The shaft 444 has two opposite ends formed with two pivot studs 446. The window frame 221 has a top portion 222 that is formed with a recess 224 which receives the pivot unit 44 therein and which is defined by a recess-confining wall 226. The recess-confining wall 226 is formed with two opposite pivot holes 227 that receive respectively the pivot studs 446 of the shaft 444, and a retaining groove 228 between the pivot holes 227. The shaft 444 of the engaging plate 442 is preferably formed with a positioning tongue 445 that projects therefrom to engage frictionally the recess-confining wall 226 of the recess 224 so as to place the panel-mounting frame 411 at the open position (see FIG. 6) and that extends into so as to engage the retaining groove 228 so as to place the panel-mounting frame 411 at a fully open position, as best shown in FIG. 7. At the open and fully open positions of FIGS. 6 and 7, an external force must be applied on the panel-mounting frame 411 so as to move the same back to the closed position.

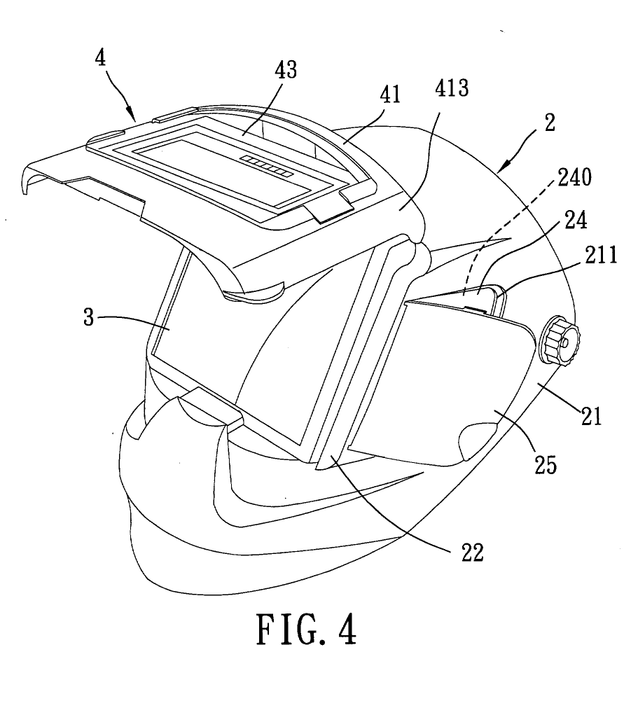

Referring again to FIG. 2, the mask body 2 has left and right side parts 21 extending rearwardly and transversely from two opposite sides of the front part 22. Each of the left and right side parts 21 is formed with a side window 240 defined by a window-confining wall 211. The side viewing members 24 are respectively mounted on the left and right side parts 21 so as to cover the side windows 240 and so as to permit vision therethrough. The side covers 25 are respectively pivoted to the window-confining walls 211 of the side windows 240 in such a manner that each of the side covers 25 is movable relative to a respective one of the left and right side parts 21 between a closed position, in which the side cover 25 confronts and covers a respective one of the side viewing members 24 (not shown), and an open position, in which the side cover 25 moves away from the respective one of the left and right side parts 21 so as to expose the respective one of the side viewing members 24, as best shown in FIGS. 2 and 4.

With the provision of the liquid crystal display unit 4 and the pivot unit 44 on the mask body 2, the user of the protective mask according to the present invention can check the actual working site after moving the panel-mounting frame 411 to the open position. Since the side covers 25 can be moved to open positions to permit the user to view left and right sides of the working site through the side viewing members 24, the aforesaid disadvantages of the prior art can be overcome accordingly.

With this invention thus explained, it is apparent that numerous modifications and variations can be made without departing from the scope and spirit of this invention. It is therefore intended that this invention be limited only as indicated in the appended claims.

I claim:

1. A protective mask comprising:
a mask body having a front part formed with a window frame that protrudes frontwardly therefrom, said window frame defining a front window;
a viewing member mounted in said window frame so as to cover said front window and adapted to permit vision therethrough;
a pivot unit; and
a liquid crystal display unit disposed frontwardly of and adjacent to said window frame, and having a liquid crystal display panel, said liquid crystal display unit being pivoted to said window frame through said pivot unit in such a manner that said liquid crystal display unit is movable relative to said window frame between a closed position, in which said liquid crystal display panel confronts and covers said viewing member, and an open position, in which said liquid crystal display panel is moved away from said window frame to expose said viewing member.

2. The protective mask as defined in claim 1, wherein said liquid crystal display unit includes a panel-mounting frame with a peripheral flange projecting rearwardly from a periphery of said panel-mounting frame toward said window frame, said peripheral flange having a top portion that is formed with a pocket, said pocket defining a pocket space therein and projecting rearwardly from said top portion and having left and right side plates and a rear plate that interconnects said side plates and that confronts said top portion, said top portion being formed with a retaining opening that confront said rear plate, said pivot unit including an engaging plate having a pivot end pivoted to said window frame above said viewing member, a free end opposite to said pivot end, and two opposite sides extending from said free end to said pivot end, said engaging plate being formed with two opposite slits extending from said free end toward said pivot end to define a latch therebetween, said latch being elastic and being formed with a protrusion, said engaging plate being inserted into said pocket space in such a manner that said side plates of said pocket abut respectively against said opposite sides of said engaging plate and that said protrusion projects into and engages said retaining opening in said top portion of said peripheral flange.

3. The protective mask as defined in claim 2, wherein said pivot unit further includes a shaft connected to said pivot end and having two opposite ends formed with two pivot studs, said window frame having a top portion that is formed with a recess which receives said pivot unit therein and which is defined by a recess-confining wall, said recess-confining wall being formed with two opposite pivot holes that receive respectively said pivot studs of said shaft, and a retaining groove between said pivot holes, said shaft being formed with a positioning tongue that projects therefrom to engage frictionally said recess-confining wall of said recess and that is extendible into and engages said retaining groove, thereby positioning said panel-mounting frame at said open position.

4. The protective mask as defined in claim 1, wherein said mask body has left and right side parts extending rearwardly and transversely from two opposite sides of said front part, each of said left and right side parts being formed with a side window defined by a window-confining wall, said protective mask further comprising two side viewing members respectively mounted on said left and right side parts so as to cover said side windows and so as to permit vision therethrough, and two side covers respectively pivoted to said window-confining walls of said side windows in such a manner that each of said side covers is movable relative to a respective one of said left and right side parts between a closed position, in which said side cover confronts and covers a respective one of said side viewing members, and an open position, in which said side cover moves away from the respective one of said left and right side parts so as to expose the respective one of said side viewing members.
